(19) United States
(12) Patent Application Publication
(10) Pub. No.: US 2016/0295535 A1
(43) Pub. Date: Oct. 6, 2016

(54) TRANSMIT PHASE MEASUREMENT AND SIGNALING IN WIFI CIRCUITS

(71) Applicant: QUALCOMM Incorporated, San Diego, CA (US)

(72) Inventors: Jubin Jose, Bound Brook, NJ (US); Enkhbayasgalan Gantsog, Ithaca, NY (US); Thomas Joseph Richardson, South Orange, NJ (US); Frank Anton Lane, Easton, PA (US); Xinzhou Wu, Hillsborough, NJ (US); Venkatesan Nallampatti Ekambaram, Somerville, NJ (US)

(21) Appl. No.: 14/678,266

(22) Filed: Apr. 3, 2015

(51) Int. Cl. H04W 56/00; H04L 7/00

(52) U.S. Cl. CPC H04W 56/003; H04W 56/0035; H04L 7/0037

(57) ABSTRACT

Systems and methods are disclosed that may determine phase offsets in wireless devices. In accordance with some embodiments, a phase of a local oscillator signal associated with transmission of data from a wireless device may be measured by generating a reference signal having a frequency that is a selected integer value times a frequency of a baseband clock signal, generating the local oscillator (LO) signal to have a frequency substantially equal to a carrier frequency of the data transmission, and mixing the reference signal and the LO signal to generate a mixed signal indicative of the phase of the LO signal.

### TECHNICAL FIELD

The present embodiments relate generally to wireless networks, and specifically to providing transmit and receive phase coherence in wireless devices.

### BACKGROUND OF RELATED ART

Wireless devices such as mobile stations (STA) may transmit wireless signals according to a number of communication protocols. For example, the IEEE 802.11 standards define at least two frequency spectrums that may be used to transmit wireless signals (e.g., the 2.4 GHz frequency spectrum and the 5 GHz frequency spectrum). Each of the frequency spectrums is divided into a number of channels. Each channel has a center frequency and a defined frequency band or range. For example, channels in the 2.4 GHz frequency spectrum each occupy a frequency band of approximately 20 MHz, while channels in the 5 GHz frequency spectrum each occupy a frequency band of approximately 20/40/80/160 MHz (e.g., depending upon the number of antennas used).

A wireless device may include one or more transceiver chains, each of which may transmit and/or receive signals on a selected channel or frequency band. When the wireless device is to transmit signals on a selected channel, baseband signals (e.g., carrying data to be transmitted) may be mixed with a local oscillator (LO) signal to up-convert the baseband signals from the baseband frequency to the carrier frequency. The resulting transmit signal may then be transmitted from a corresponding transmit chain of the wireless device. The carrier frequency is typically near the center frequency of the selected channel.

The phase of the transmit (or carrier) signal may vary over time, for example, because of phase offsets introduced in and/or between transmit chains, changing channel conditions, and receiver mismatch. For example, two baseband data signals that are identical in phase and frequency may have different transmit phases over time and/or between channels. Uncertainties in the transmit phase (e.g., the carrier signal phase) may result in undesirable timing errors. These timing errors may not only degrade transmission performance but also degrade the accuracy of estimated Time of Arrival (ToA) information, Angle of Arrival (AoA) information, and/or estimated Doppler information. For example, because timing accuracy is related (e.g., proportional) to the width of the frequency band used by the wireless devices, the accuracy of ToA and AoA information may be increased by obtaining channel condition estimates for multiple frequency bands or channels, and then combining the channel condition estimates using a suitable technique such as channel stitching. In this manner, channel estimates may be obtained over an entire frequency spectrum, which in turn may result in increased timing accuracy. Coherent channel stitching depends upon accurate phase estimates of the signals exchanged between wireless devices over multiple channels and over a period time.

Thus, is important to maintain accurate estimates of the phases of the transmit signals of a wireless device.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

An apparatus and method are disclosed that may maintain accurate phase estimates of transmit signals (and receive signals) of a wireless device over time and/or between multiple channels or transceiver chains. Maintaining accurate estimates of transmit signal phases over time may increase the timing accuracy associated with transmitting signals from and/or receiving signals by a wireless device. Increasing such timing accuracy may not only reduce transmission errors but may also increase the accuracy of estimated AoA information, ToA information, and/or Doppler information. More specifically, for at least some example embodiments, accuracy of the phase estimates of the transmit signals (and receive signals) may be improved (e.g., as compared with conventional solutions) by using one or more reference clock signals to measure the phase of the transmit signals (and receive signals).

More specifically, for example embodiments, the wireless device may determine a phase of a local oscillator (LO) signal used for transmitting data on a selected channel from the wireless device. The wireless device may include a baseband processor clocked by a baseband clock signal. The phase of the first LO signal may be determined by generating a reference signal based at least in part on the baseband clock signal, wherein a frequency of the reference signal is within a predetermined value or range of a center frequency of the selected channel; generating a signal based at least in part on the reference signal and the first LO signal, the generated signal including phase information of the first LO signal; and sampling the generated signal to determine the phase of the first LO signal. For some embodiments, the frequency of the reference signal is an integer multiple of a frequency of the baseband clock signal.

For some embodiments, the reference signal may be generated from the baseband clock signal, for example, by frequency multiplying the baseband clock signal by the integer multiple. For other embodiments, the baseband clock signal may be generated from the reference signal, for example, by frequency dividing the reference signal by the integer multiple. For example embodiments, the baseband clock signal and the reference signal may have a zero phase offset or a constant non-zero phase offset with respect to each other.

The wireless device may phase-shift data packets in the baseband processor based, at least in part, on the determined phase of the first LO signal. Because the first LO signal may be used to up-convert data signals from the baseband frequency to the carrier frequency, adjusting the phase of the baseband clock signal based (at least in part) on the determined phase of the first LO signal may align the phase of the transmit signals (e.g., the carrier signal) with the phase of the baseband clock signal. The determined transmit phase may be transmitted to another wireless device (e.g., in one or more subsequent packets or frames), which may use the determined transmit phase to align its receive clocks with the measured phase of the transmit signal.

For at least some embodiments, the reference signal may be a second LO signal, for example, where the first LO signal is associated with a first transceiver chain and the second LO signal is associated with a second transceiver chain. For these embodiments, the sampled signal may indicate the relative phase between the first and second LO signals, and thus the relative phase between the first and second transceiver chains.

### BRIEF DESCRIPTION OF THE DRAWINGS

The example embodiments are illustrated by way of example and are not intended to be limited by the figures of the accompanying drawings, where:

FIG. 1 shows a block diagram of a WLAN system within which the example embodiments may be implemented.

FIG. 2 shows a block diagram of a wireless station (STA) in accordance with example embodiments.

FIG. 3 shows a block diagram of an example wireless transceiver of the STA of FIG. 2.

FIG. 4 is an example sequence diagram depicting the transmission of a number of packets having different phase and frequency offsets with respect to a reference frequency.

FIG. 5A shows an example clock generation circuit to generate a baseband clock signal based on a reference clock signal.

FIG. 5B shows an example clock generation circuit to generate the reference clock signal based on the baseband clock signal.

FIG. 6A shows a block diagram of an example phase offset determination circuit.

FIG. 6B shows a block diagram of another phase offset determination circuit.

FIG. 7 is an example plot depicting relative frequency offsets of two signals that may be used in example embodiments.

FIG. 8 shows an illustrative flow chart depicting one example operation for determining a phase of a signal.

FIG. 9 shows an illustrative flow chart depicting another example operation for determining a phase of a signal.

Like reference numerals refer to corresponding parts throughout the drawing figures.

### DETAILED DESCRIPTION

The example embodiments are described below in the context of determining phase offsets in Wi-Fi systems for simplicity only. It is to be understood that the example embodiments are equally applicable to determining phase offsets for other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including an AP and a plurality of STAs, the present embodiments are equally applicable to other WLAN systems including, for example, WLANs including a plurality of APs, peer-to-peer (or Independent Basic Service Set) systems, Wi-Fi Direct systems, and/or Hotspots. In addition, although described herein in terms of exchanging data packets between wireless devices, the present embodiments may be applied to the exchange of any data unit, packet, and/or frame between wireless devices. Thus, the term “data packet” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

Further, as used herein, the term “transmit phase” may refer to the phase of a local oscillator signal used to up-convert data signals from a baseband frequency to a carrier frequency. Thus, the term “transmit phase” may refer to the phase of the local oscillator signal and/or to the phase of a carrier signal used for transmitting data to another wireless device. The term “transmit signals” as used herein may refer to data signals transmitted (e.g., modulated onto a carrier signal) from one wireless device to another wireless device.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The example embodiments are not to be construed as limited to specific examples described herein but rather to include within their scopes all embodiments defined by the appended claims.

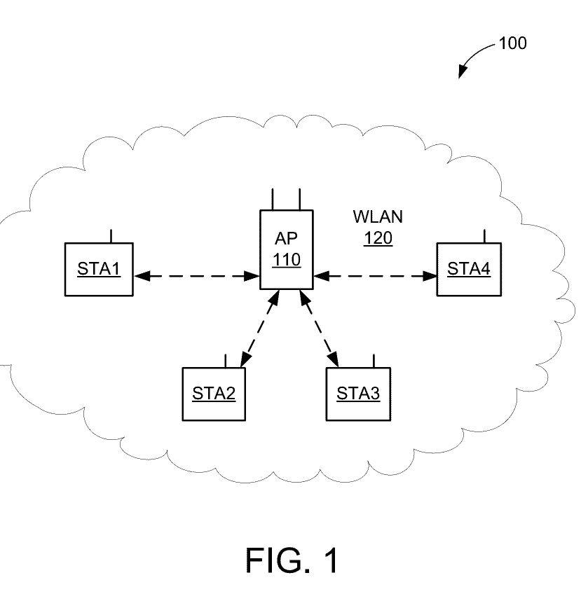

FIG. 1 is a block diagram of a wireless network system 100 within which the example embodiments may be implemented. The wireless network system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique MAC address that is programmed therein by, for example, the manufacturer of the access point. Similarly, each of STA1-STA4 is also assigned a unique MAC address. For some embodiments, the wireless network system 100 may correspond to a multiple-input multiple-output (MIMO) wireless network.

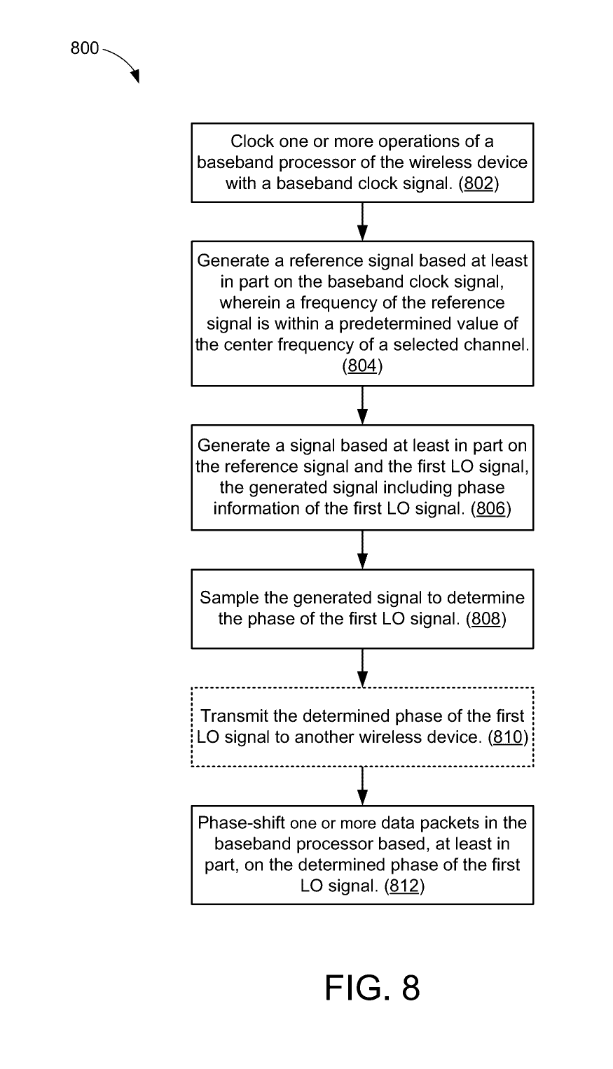

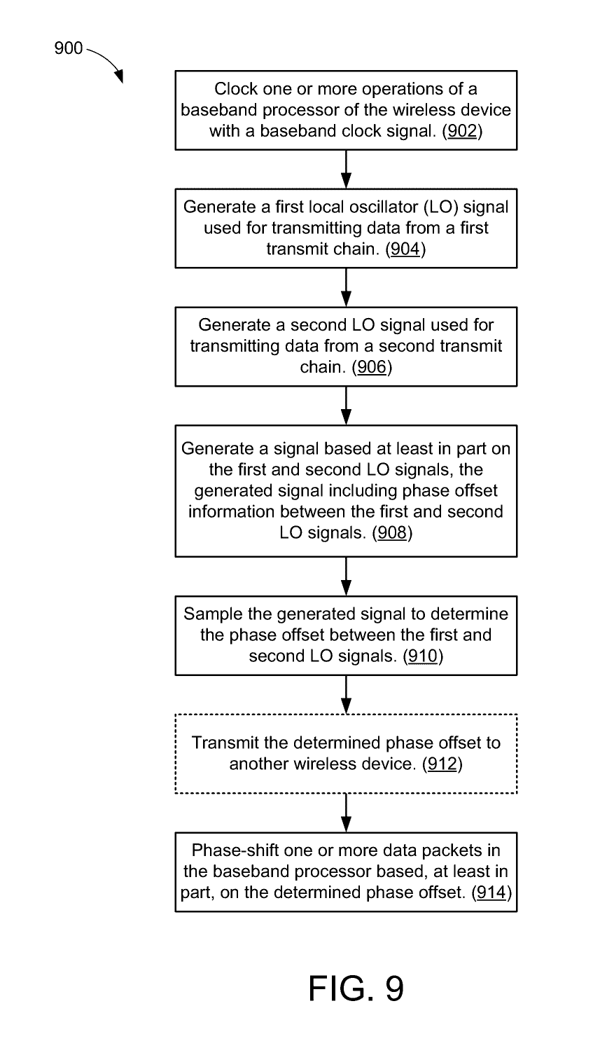

Each of stations STA1-STA4 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 8 and 9.

The one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within stations STA1-STA4 may be any technically feasible transceiver such as a ZigBee transceiver described by a specification from the ZigBee specification, a WiGig transceiver, and/or a HomePlug transceiver described a specification from the HomePlug Alliance.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one embodiment, AP 110 may include a transceiver, a network interface, one or more processing resources, and one or more memory resources. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 8 and 9.

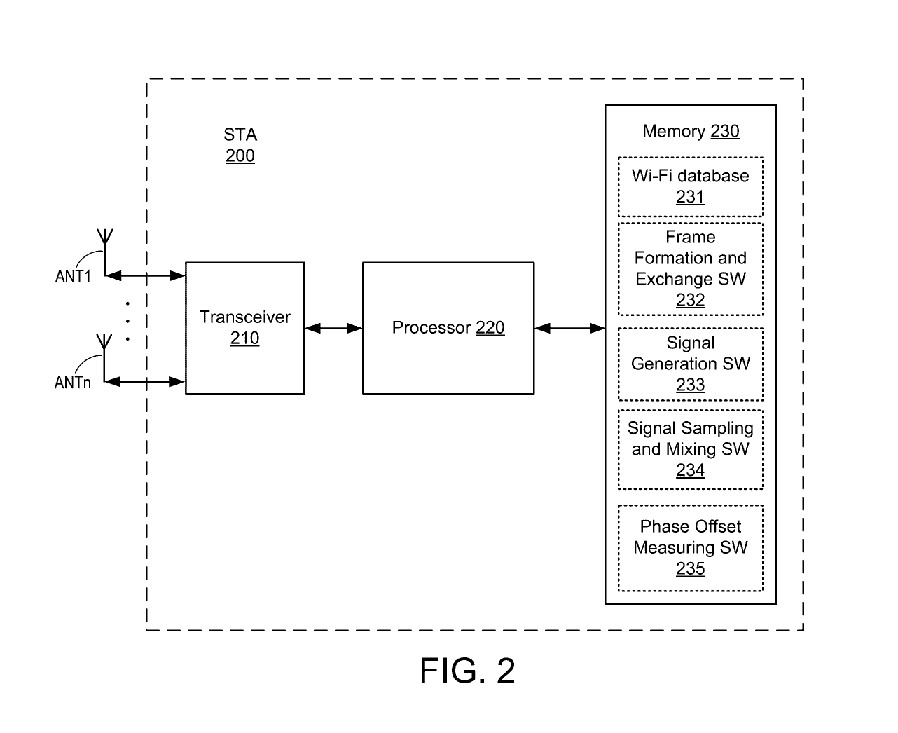

FIG. 2 shows a STA 200 that is one embodiment of at least one of the stations STA1-STA4 of FIG. 1. The STA 200 may include a transceiver 210, a processor 220, a memory 230, and a number of antennas (ANT1-ANTn). The transceiver 210 may be coupled to antennas ANT1-ANTn either directly or through an antenna selection circuit (not shown for simplicity). The transceiver 210 may be used to transmit signals to and receive signals from AP 110 and/or other STAs (see also FIG. 1) via one or more of antennas ANT1-ANTn, and may be used to scan the surrounding environment to detect and identify nearby access points (e.g., access points within range of STA 200 and/or other STAs). Although not shown in FIG. 2 for simplicity, the transceiver 210 may include any number of transmit chains to process and transmit signals to other wireless devices via antennas ANT1-ANTn, and may include any number of receive chains to process signals received from antennas ANT1-ANTn. Thus, for example embodiments, the STA 200 may be configured for multiple-input, multiple-output (MIMO) operations. The MIMO operations may include single-user MIMO (SU-MIMO) operations and multi-user MIMO (MU-MIMO) operations.

For purposes of discussion herein, processor 220 is shown as coupled between transceiver 210 and memory 230. For actual embodiments, transceiver 210, processor 220, and/or memory 230 may be connected together using one or more buses (not shown for simplicity). Although only one transceiver 210 is shown in FIG. 2, actual embodiments may include any number of transceivers that may operate in any number of frequency bands and/or according to any number of different wireless communication protocols (e.g., as described above with respect to FIG. 1). Further, although only one processor 220 is shown in FIG. 2, actual embodiments may include any number of processors.

Memory 230 may include a Wi-Fi database 231 that may store location data, configuration information, data rates, MAC addresses, timing information, transmit and/or receive phase information, and other suitable information of a number of access points and/or stations. Memory 230 may also include a non-transitory computer-readable storage medium (e.g., one or more nonvolatile memory elements, such as EPROM, EEPROM, Flash memory, a hard drive, and so on) that may store the following software modules (SW):
a frame formation and exchange software module 232 to facilitate the creation and exchange of frames (e.g., data frames, ACK frames, request frames, response frames, beacon frames, management frames, association frames, control frames, action frames, fine timing measurement (FTM) frames, and so on);
a signal generation software module 233 to facilitate the generation of local oscillator and reference clock signals, for example, as described for one or more operations of FIGS. 8 and 9;
a signal sampling and mixing software module 234 to facilitate the sampling, filtering, and mixing of oscillator signals, for example, as described for one or more operations of FIGS. 8 and 9; and
a phase offset measuring software module 235 to facilitate the measuring of phase offsets in mixed and sampled oscillator signals, for example, as described for one or more operations of FIGS. 8 and 9.
   Each software module includes instructions that, when executed by processor 220, cause STA 200 to perform the corresponding functions. The non-transitory computer-readable medium of memory 230 thus includes instructions for performing all or a portion of the operations of FIGS. 8 and/or 9.

Processor 220, which is coupled to transceiver 210 and memory 230, may be one or more suitable processors capable of executing scripts or instructions of one or more software programs stored in STA 200 (e.g., within memory 230). For example, processor 220 may execute the frame formation and exchange software module 232 to facilitate the creation and/or exchange of various types of frames with one or more other wireless devices. Processor 220 may also execute the signal generation software module 233 to facilitate the generation of local oscillator and reference clock signals. Processor 220 may also execute the signal sampling and mixing software module 234 to facilitate the sampling, filtering, and mixing of signals. Processor 220 may also execute the phase offset measuring software module 235 to facilitate the measuring of phase offsets between signals.

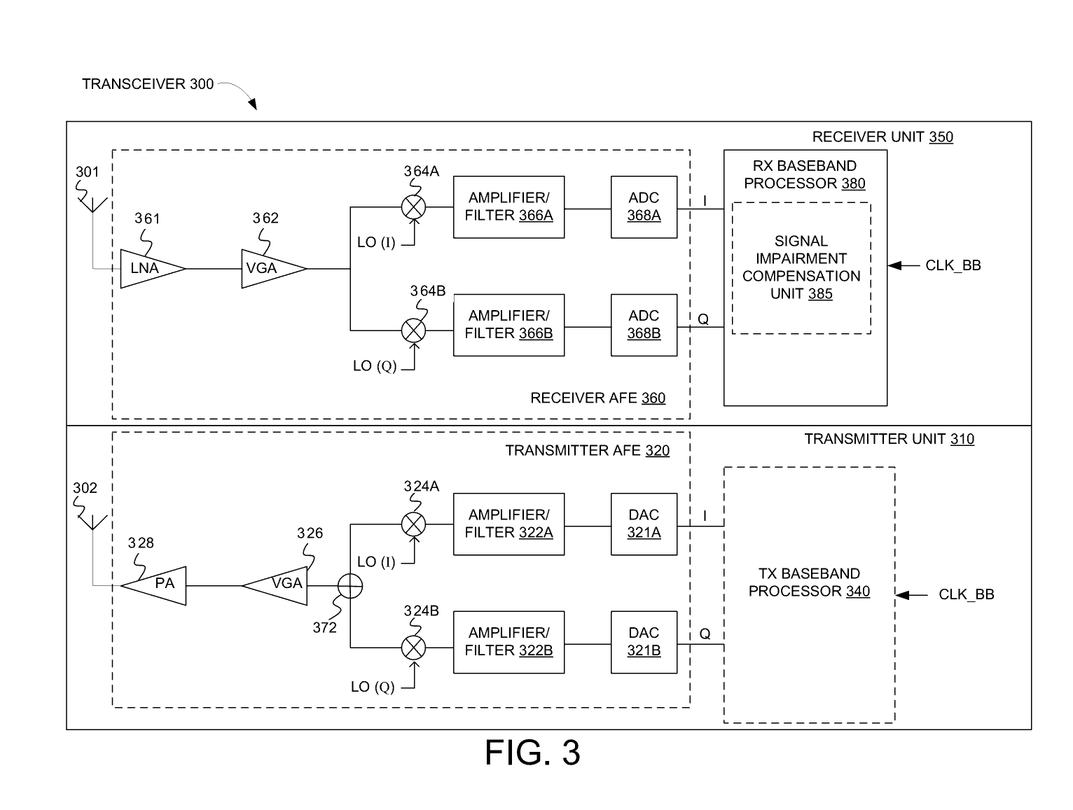

FIG. 3 is a block diagram of an example transceiver 300 that may be one embodiment of the transceiver 210 of the STA 200 of FIG. 2. Transceiver 300, which is shown in FIG. 3 as including a transmitter unit 310 and a receiver unit 350, may utilize quadrature amplitude modulation (QAM) schemes for exchanging data (e.g., symbols) with other wireless devices. Further, although shown in FIG. 3 as including a single-chain transmitter unit 310 and a single-chain receiver unit 350, the transceiver 300 may include any number (e.g., a multitude) of transmit chains and receive chains, for example, to provide MIMO capabilities, dual-band operation, channel diversity, and so on.

The transmitter unit 310 may include one or more antennas 302, a transmitter analog front end (AFE) 320, and a transmitter baseband processor 340. The receiver unit 350 includes one or more antennas 301, a receiver AFE 360, and a receiver baseband processor 380. In some embodiments, the receiver baseband processor 380 may include a signal impairment compensation unit 385 for estimating and compensating for signal impairments introduced both in the transmitter and receiver, as depicted in the example of FIG. 3.

In the example of FIG. 3, the transmitter AFE 320 includes a digital-to-analog converter (DAC) 321A for the in-phase (I) signal path, amplifier/filter 322A for the I signal path, a local oscillator (LO) mixer 324A for the I signal path, a DAC 321B for the quadrature (Q) signal path, amplifier/filter 322B for the Q signal path, an LO mixer 324B for the Q signal path, a combiner 372, a variable gain amplifier (VGA) 326, and a power amplifier (PA) 328. The mixers 324A and 324B up-convert the I and Q signals from baseband directly to the carrier frequency by mixing the I and Q signals with local oscillator signals LO(I) and LO(Q), where the frequency of the local oscillator signals LO(I) and LO(Q) may be the carrier frequency. Mismatch between mixers 324A and 324B, between amplifiers/filters 322A and 322B, and/or between DACs 321A and 321B may result in transmitter-side I/O mismatch. The combiner 372 combines the up-converted I and Q signals into a transmit signal that may be amplified by VGA 326 and PA 328 before wireless transmission from antenna 302 (e.g., at the carrier frequency for a channel selected for transmission).

The receiver AFE 360 includes a low-noise amplifier (LNA) 361, a VGA 362, an LO mixer 364A for the I signal path, amplifier/filter 366A for the I signal path, an analog-to-digital converter (ADC) 368A for the I signal path, an LO mixer 364B for the Q signal path, amplifier/filter 366B for the Q signal path, and an ADC 368B for the Q signal path. The mixers 364A and 364B directly down-convert the received signal into baseband I and Q signals by mixing the received signal with local oscillator signals LO(I) and LO(Q), where the frequency of the local oscillator signals (as generated by a local oscillator, not shown in FIG. 3 for simplicity) is ideally the carrier frequency.

Mismatch between mixers 364A and 364B, between amplifiers/filters 366A and 366B, and/or between ADCs 368A and 368B may result in receiver-side I/O mismatch. A difference between the frequency of the local oscillator signals in the receiver unit 350 of a receiver and the corresponding frequency of local oscillator signals in the transmitter unit 310 of a transmitter results in carrier frequency offset. Further, a difference between the phase and/or frequency of the local oscillator signals in the receiver unit 350 of the receiver and the corresponding phase and/or frequency of local oscillator signals in the transmitter unit 310 of the transmitter may result in carrier phase offset.

The components described with reference to FIG. 3 are exemplary only. In various embodiments, one or more of the components described may be omitted, combined, or modified, and additional components may be included. For instance, in some embodiments, the transmitter unit 310 and receiver unit 350 may share one or more common antennas, or may have various additional antennas and transmitter/receiver chains. In some implementations, the transceiver 300 may include less or more filter and/or amplifier circuitry (e.g., blocks 322 and 366 of FIG. 3).

As depicted in the example of FIG. 3, the TX baseband processor 340 may include or receive a baseband clock signal (CLK_BB) to generate the baseband I and Q signals for the transmitter AFE 320, and the RX baseband processor 380 may include or receive CLK_BB to process the baseband I and Q signals received from receiver AFE 360. The center frequencies of Wi-Fi channels may not have any specific relationship with the frequency of BB_CLK. For example, when the frequency of BB_CLK is 320 MHz, then none of the center frequencies of the channels in either the 2.4 GHz frequency spectrum or the 5 GHz frequency spectrum are integer multiples of the CLK_BB frequency. For one example, the center frequency of channel 1 in the 2.4 GHz band equals 2412 MHz, which is 7.5375 times the CLK_BB frequency of 320 MHz. For another example, the center frequency of channel 40 in the 5 GHz band equals 5220 MHz, which is 16.3125 times the CLK_BB frequency of 320 MHz. Because the carrier signal frequencies may not be integer multiples of the CLK_BB frequency, there may be unknown phase offsets between the baseband signals and the transmit signals (e.g., the carrier signals). These unknown phase offsets may cause signals transmitted at different times to have different (and perhaps unknown) phases, even though all the signals may have the same phase in baseband.

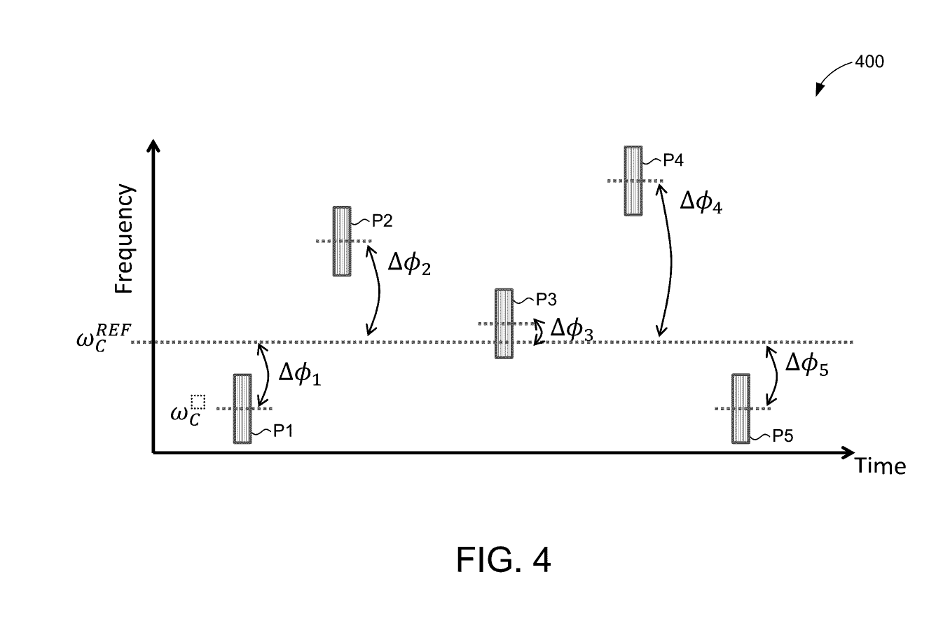

For example, FIG. 4 is an example sequence diagram 400 depicting the transmission of a number of packets P1-P5 having different phase and frequency offsets with respect to a reference frequency ω_{c,ref}. As shown in FIG. 4, although the packets P1-P5 may have the same phase and frequency in baseband, unknown phase offsets of the LO signals in the AFEs 320 and 360 of FIG. 3 may cause the packets P1-P5 to have different transmit phases (e.g., transmitted on different phases of the carrier signal). The phase offsets of packets P1-P5 are illustrated in FIG. 4 as Δφ1-Δφ5, respectively.

In accordance with example embodiments, a wireless device may use one or more reference clock signals to determine the phases of transmit signals over time and/or to determine the phases of transmit signals associated with different transceiver chains. The determined phase information may be used to estimate phase offsets between different transmit signals, and the resulting estimated phase offsets may be used to calibrate one or more components in the transmitter device and/or in the receiver device (e.g., so that the transmit and receive phases align). For at least one embodiment, estimated phase offset information may be embedded within one or more frames and transmitted to the receiver device (e.g., to reduce timing errors associated with receiving the signals). The resulting estimated phase offsets may also be used to improve the accuracy of ToA information, AoA information, and/or Doppler estimation.

The one or more reference clock signals, hereinafter denoted as CLK_REF, may have a frequency that is an integer multiple (N) of the frequency of CLK_BB. The value of the integer N may be selected so that CLK_REF has a frequency within the frequency band of a selected operating channel (e.g., so that the frequency of CLK_REF is within a predetermined value or range of the center frequency of the selected operating channel). For example, if a wireless device is operating on channel 40 of the 5 GHz frequency spectrum, which has a center frequency of 5220 MHz, then a value of N=16 may be selected as the integer multiple, for example, so that CLK_REF has a frequency equal to 320*16=5120 MHz (e.g., which is only 10 MHz away from the center frequency of channel 40). Because the frequency of CLK_REF is an integer multiple of the frequency of CLK_BB, the phase offset between clock signals CLK_BB and CLK_REF may remain constant (e.g., clock signals CLK_BB and CLK_REF may have either a zero phase offset or a constant non-zero phase offset relative to each other). Maintaining a constant phase offset between clock signals CLK_BB and CLK_REF, along with selecting a CLK_REF frequency that is within a predetermined value or range of the frequency of the LO signals (e.g., and thus within a predetermined value or range of the center frequency of the selected operating channel), may allow the wireless device to accurately determine the phase of transmit signals using CLK_REF.

More specifically, CLK_REF and the LO signal may be mixed together to generate a signal including phase offset information between CLK_REF and the LO signal, and the generated signal may then be sampled to generate a sampled signal indicative of the phase offset between CLK_REF and the LO signal. Because CLK_REF may have a known phase, the generated signal may include phase information of the LO signal, and thus the phase of the LO signal may be determined from the sampled signal. The generated signal and/or the LO signal may be filtered (e.g., using a low-pass filter) to remove unwanted harmonics. For the example embodiments, the sampling frequency may be less than the difference between the CLK_REF frequency and the LO signal frequency without degrading accuracy of the phase offset determination, for example, because the frequency difference between CLK_REF and the LO signal is known (and may remain constant).

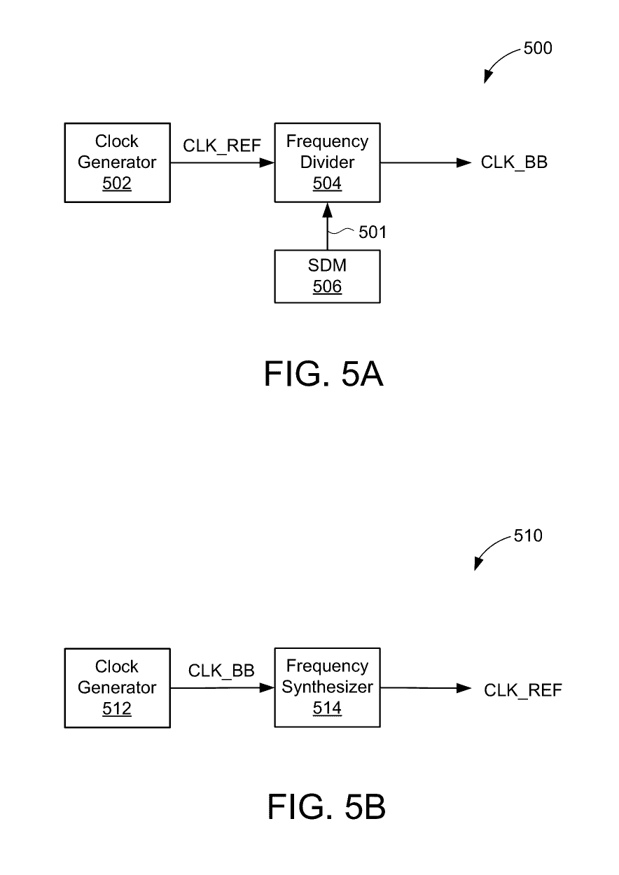

FIG. 5A depicts an example clock generation circuit 500 that may be used to generate CLK_REF and CLK_BB signals that, in accordance with example embodiments, may have a constant (or zero) phase offset with respect to each other. The clock generation circuit 500, which may be implemented within AFE 320/360 and/or within baseband processors 340/380, may include a clock generator 502, a frequency divider 504, and an optional sigma-delta modulation (SDM) circuit 506. The clock generator 502, which may be any suitable circuit for generating an oscillating signal (e.g., and may include or be associated with at least a crystal, a voltage-controlled oscillator (VCO), and/or a delay-locked loop (DLL) or phase-locked loop (PLL)), generates CLK_REF. For some embodiments, clock generator 502 generates CLK_REF to have a selected frequency that is (1) within or near a frequency band associated with a selected operating channel of STA 200 of FIG. 2 (e.g., so that the frequency of CLK_REF is within a predetermined value or range of the center frequency of the selected operating channel) and (2) that is an integer multiple of CLK_BB (e.g., f_{CLK}_{_}_{REF}=NI_{CLK}_{_}_{BB}).

The frequency divider 504, which may be any suitable frequency divider, frequency divides CLK_REF by the selected value of N to generate CLK_BB. In other words, frequency divider 504 generates CLK_BB from CLK_REF so that CLK_BB has a frequency that is 1/N times the frequency of CLK_BB (and so that the CLK_REF and CLK_BB signals have the same phase). For some embodiments, the value of N may be predetermined. For other embodiments, the value of N may be adjusted (e.g., dynamically).

For example, when STA 200 is to operate on a selected channel having a center frequency of 5220 MHz (e.g., channel 40 in the 5 GHz frequency band), then clock generator 502 may set the frequency of CLK_REF to be an integer value N=16 times the frequency of CLK_BB, for example, which may set the frequency of CLK_REF to 320*16=5120 MHz when the CLK_BB signal has a frequency of 320 MHz. For this example, the frequency divider 504 may frequency divide CLK_REF by N=16 to generate CLK_BB (e.g., so that the CLK_BB signal has a frequency of 5120/16=320 MHz).

The SDM circuit 506, which is optional, may provide a control signal 501 that, in turn, may be used by frequency divider 504 to achieve a non-integer value of N (e.g., so that frequency divider 504 may operate as a fractional frequency divider).

FIG. 5B depicts another example clock generation circuit 510 that may be used to generate CLK_BB and CLK_REF signals that, in accordance with example embodiments, may have a constant (or zero) phase offset with respect to each other. The clock generation circuit 510, which may be implemented within AFE 320/360 and/or within baseband processors 340/380, may include a clock generator 512 and a frequency synthesizer 514. The clock generator 512, which may be any suitable circuit for generating an oscillating signal, generates the baseband clock signal CLK_BB. The frequency synthesizer 514, which may be any suitable circuit that multiplies an input clock signal by a selected integer value N to generate a frequency-multiplied signal, multiplies the CLK_BB signal by the selected value of N to generate the CLK_REF signal. For some embodiments, clock generator 512 generates CLK_BB to have a desired baseband frequency (e.g., 320 MHz), and frequency synthesizer 514 multiplies CLK_BB by the selected value of N to generate the CLK_REF signal to have a frequency that is (1) within or near a frequency band associated with an operating channel of STA 200 of FIG. 2 (e.g., so that the frequency of CLK_REF is within a predetermined value or range of the center frequency of the selected operating channel) and (2) that is an integer multiple of CLK_BB (e.g., f_{CLK}_{_}_{REF}=N*f_{CLK}_{_}_{BB}).

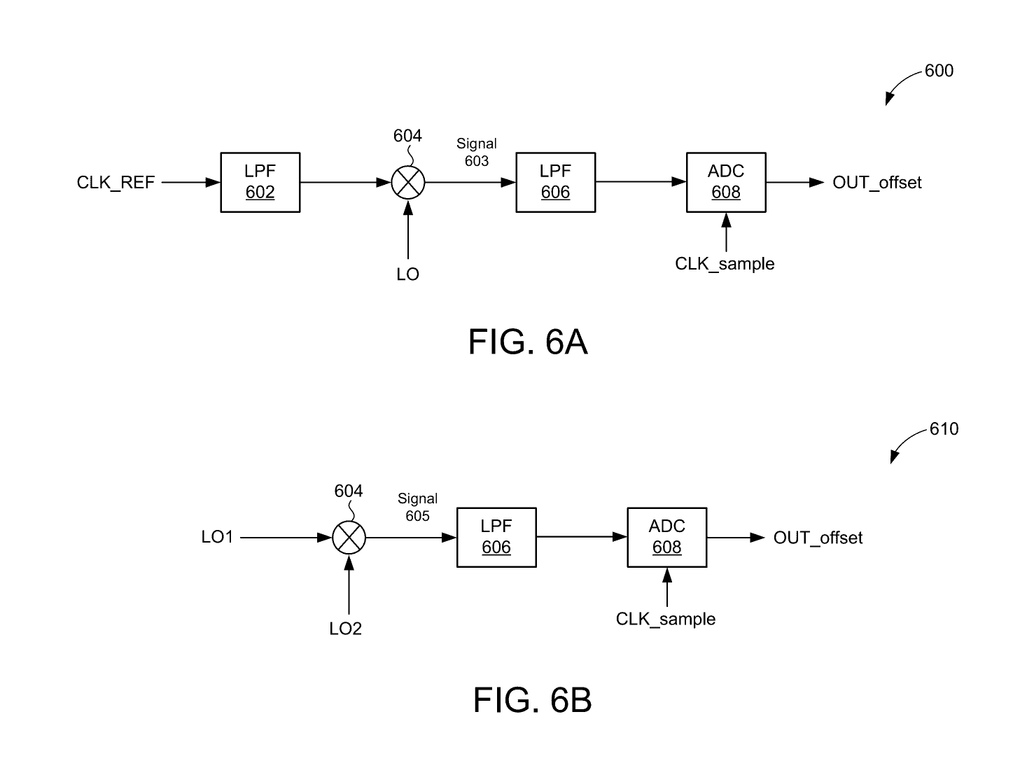

FIG. 6A shows an example phase offset determination circuit 600. The phase offset determination circuit 600 is shown to include a first low-pass filter (LPF) 602, a mixer 604, a second LPF 606, and an analog-to-digital converter (ADC) 608. Referring also to FIGS. 3 and 5A-5B, the first LPF 602 receives the CLK_REF signal, filters the CLK_REF signal (e.g., to remove any unwanted harmonics), and provides the filtered CLK_REF signal to a first input of mixer 604.

The mixer 604 includes a second input to receive a local oscillator signal (LO), and an output coupled to second LPF 606. The LO signal shown in FIG. 6A may be any of the local oscillator signals LO(I) and/or LO(Q) associated with the transceiver 300 of FIG. 3. The mixer 604 mixes the filtered CLK_REF signal and the LO signal together to generate a signal 603. The signal 603, which may indicate relative phase and frequency differences between the LO signal and CLK_REF, may be filtered by second LPF 606 (e.g., to remove any unwanted harmonics).

The filtered signal 603 is provided as an input to ADC 608, which samples the filtered signal 603 using a sampling clock signal (CLK_sample) to generate an output offset signal (OUT_offset). Note that although the frequency difference between the LO signal and CLK_REF may be greater than the frequency of CLK_sample, the sampled signals output from the ADC 608 may still be used to measure the phase offset, for example, because the frequency difference between the LO signal and CLK_REF is known.

The OUT_offset signal may indicate the relative phase and frequency differences between the LO signal and CLK_REF. Accordingly, for example embodiments, the OUT_offset signal may be used to estimate the transmit phase of transceiver 300 of FIG. 3 for each of a number of packets or symbols transmitted over a period of time. The OUT_offset signal may also be used to adjust the transmit phase of transceiver 300 (e.g., by adjusting the phase of local oscillator signals LO(I) and/or LO(Q)).

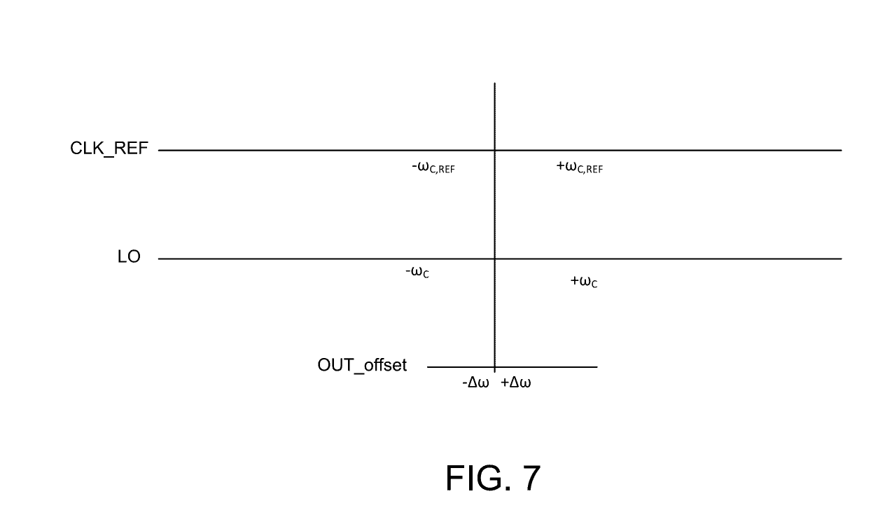

For illustrative purposes, let the LO signal have an angular frequency of ω_{C} and a phase of φ, and let the CLK_REF signal have an angular frequency of ω_{C,REF} and a phase of φ+φₐ, where φₐ is the phase offset of CLK_REF relative to the LO signal (e.g., relative to the carrier signal). The resulting output signal OUT_offset may have an angular frequency of Δω and a phase of φₐ, which represents the difference in frequency and phase between the LO signal and CLK_REF. An example relationship between CLK_REF, the LO signal, and the output signal OUT_offset is shown in FIG. 7.

FIG. 7 is an example diagram 700 illustrating the relative frequencies of the LO signal, the CLK_REF signal, and the output signal OUT_offset of FIG. 6A. The CLK_REF signal includes frequency components at +ω_{C,REF} and −ω_{C,REF} (where ω_{C,REF}=2π*f_{REF}), and the LO signal includes frequency components at +ω_{C} and −ω_{C} (for simplicity, harmonics of the LO and CLK_REF signals that may be filtered by at least LPF 602 are not shown in FIG. 7). Thus, the resulting output signal OUT_offset from the phase offset determination circuit 600 may include components +Δω and −Δω indicative of the relative phase difference between the LO signal and CLK_REF.

As mentioned above, the OUT_offset signal may also be used to estimate and/or adjust the transmit phase of transceiver 300. More specifically, the OUT_offset signal may be used to estimate the transmit phase of transceiver 300 of FIG. 3 for each of a number of packets or symbols transmitted over a period of time. Estimates of the transmit phase of transceiver 300 over a period of time may be used to increase the timing accuracy of transceiver 300 which, in turn, may improve the accuracy of estimated ToA and/or AoA information. As described above, improving the accuracy of estimated ToA and/or AoA information may not only allow for more accurate channel condition estimates but also allow for more coherent channel stitching operations. Accordingly, the ability to accurately determine the transmit phase for packets over a period of time may improve transmission and/or may improve the accuracy of ranging operations.

For at least some embodiments, the estimated transmit phase may be embedded into one or more packets or frames transmitted to a receiving device. The receiving device may use estimates of the transmit phase (received over time from the transmitting device) to align the phase of the receive clock signal (e.g., the LO signals and/or sampling clock signals in the receiving device) with the transmit phase, which in turn may reduce the packet error rate (PER).

The phase offset determination circuit 600 of FIG. 6A may also be used to estimate the frequency and phase differences between local oscillator signals. For example, FIG. 6B shows another example phase offset determination circuit 610. The phase offset determination circuit 610 of FIG. 6B is similar to the phase offset determination circuit 600 of FIG. 6A, except that the first LPF 602 may be omitted, and the mixer 604 of FIG. 6B is configured to receive a first local oscillator signal (LO1) and a second local oscillator signal (LO2). For one example embodiment, the signal LO1 of FIG. 6B may be the in-phase local oscillator signal LO(I) associated with transceiver 300, and the signal LO2 of FIG. 6B may be the quadrature local oscillator signal LO(Q) associated with transceiver 300. For another example embodiment in which transceiver 300 includes two or more transceiver chains (e.g., where the transmitter AFE 320 and the receiver AFE 360 may be replicated for each transceiver chain), the signal LO1 of FIG. 6B may be an LO signal in a first transmit chain of transceiver 300, and the signal LO2 of FIG. 6B may be an LO signal in a second transmit chain of transceiver 300.

The mixer 604 mixes the LO1 and LO2 signals together to generate a signal 605. The signal 605, which may indicate the relative frequency and phase difference between the LO1 and LO2 signals, may be filtered by LPF 606 (e.g., to remove any unwanted harmonics in the signal 605). The filtered signal 605 is provided as an input to ADC 608, which may sample the filtered signal 605 using CLK_sample to generate the output signal, OUT_offset. For the example embodiment of FIG. 6B, the OUT_offset signal may indicate the relative phase difference between the LO1 and LO2 signals. In this manner, the signal OUT_offset may represent the carrier phase offset between two transmit (or receive) chains of a transceiver (e.g., such as transceiver 300 of FIG. 3). The signal OUT_offset may also be used to represent the carrier phase offset between a transmit chain of a transmitting device and a receive chain of a receiver device.

FIG. 8 is an illustrative flow chart depicting an example operation 800 for determining a phase of a local oscillator (LO) signal that may be used for transmitting data from a wireless device. The example operation is described below with respect to the wireless device 200 depicted in FIGS. 2-3 for illustrative purposes; it is be understood that operation 800 may be performed by other suitable wireless devices. Referring also to FIGS. 2, 3, 5A-5B, and 6A, the wireless device 200 may clock one or more operations of its baseband processor 340 using a baseband clock signal CLK_BB (802). The wireless device 200 then generates a reference signal (CLK_REF) based at least in part on the baseband clock signal (CLK_BB), wherein a frequency of the reference signal is within a predetermined value or range of a center frequency of the selected channel (804). The wireless device 200 then generates a signal based at least in part on the reference signal and the first LO signal, the generated signal including phase information of the first LO signal (806).

Then, the wireless device 200 may sample the generated signal to determine the phase of the first LO signal (808).

Thereafter, the wireless device 200 may (optionally) transmit the determined phase of the first LO signal to another wireless device (810). As described above, the other wireless device may use the determined phase of the first LO signal as an estimate of the transmit phase offset to calibrate one or more of its receive chains (e.g., to align the phase of a receive clock with the phase of the transmit signal).

The wireless device 200 may also phase-shift one or more packets in its baseband processor 340 based, at least in part, on the determined phase of the first LO signal (812). In this manner, the wireless device 200 may ensure that the phase of the transmit signal is aligned with the phase of the baseband clock signal (CLK_BB).

FIG. 9 is an illustrative flow chart depicting an example operation 900 for determining a phase offset between a first local oscillator (LO) signal and a second LO signal. The example operation is described below with respect to the wireless device 200 depicted in FIGS. 2-3 for illustrative purposes; it is be understood that operation 900 may be performed by other suitable wireless devices. Referring also to FIGS. 2, 3, 5A-5B, and 6B, the wireless device 200 may clock one or more operations of its baseband processor 340 using a baseband clock signal CLK_BB (902). The wireless device 200 may generate a first local oscillator (LO) signal used for transmitting data from a first transmit chain (904), and may generate a second LO signal used for transmitting data from a second transmit chain (906). Next, the wireless device 200 may generate a signal based at least in part on the first and second LO signals, the generated signal including phase offset information between the first and second LO signals (908). The wireless device 200 may then sample the generated signal to determine the phase offset between the first and second LO signals (910). The wireless device 200 may (optionally) transmit the determined phase offset to another wireless device (912). The wireless device 200 may then phase-shift one or more data packets in the baseband processor based, at least in part, on the determined phase offset (914).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of determining a phase of a first local oscillator (LO) signal used for transmitting data on a selected channel from a wireless device, the method performed by the wireless device and comprising:
clocking one or more operations of a baseband processor of the wireless device with a baseband clock signal;
generating a reference signal based at least in part on the baseband clock signal, wherein a frequency of the reference signal is within a predetermined value of a center frequency of the selected channel;
generating a signal based at least in part on the reference signal and the first LO signal, the generated signal including phase information of the first LO signal; and
sampling the generated signal to determine the phase of the first LO signal.

2. The method of claim 1, wherein the frequency of the reference signal is an integer multiple of a frequency of the baseband clock signal.

3. The method of claim 1, further comprising:
transmitting the determined phase of the first LO signal to another wireless device.

4. The method of claim 1, further comprising:
phase-shifting one or more data packets in the baseband processor based, at least in part, on the determined phase of the first LO signal.

5. The method of claim 1, wherein the baseband clock signal and the reference signal have a zero phase offset relative to each other.

6. The method of claim 1, wherein the baseband clock signal and the reference signal have a constant non-zero phase offset relative to each other.

7. The method of claim 1, wherein the first LO signal is associated with a first transmit chain of the wireless device, the reference signal is a second LO signal associated with a second transmit chain of the wireless device, and the generated signal includes phase offset information between the first LO signal and the second LO signal.

8. The method of claim 7, wherein generating the signal comprises:
mixing the first LO signal and the second LO signal together in a mixer.

9. A wireless device, comprising:
a baseband processor;
at least one transceiver to wirelessly transmit data on a selected channel based, at least in part, on a first local oscillator (LO) signal;
one or more processors; and
a memory storing one or more programs comprising instructions that, when executed by the one or more processors, cause the wireless device to:
clock the baseband processor with a baseband clock signal;
generate a reference signal based at least in part on the baseband clock signal, wherein a frequency of the reference signal is within a predetermined value of a center frequency of the selected channel;
generate a signal based at least in part on the reference signal and the first LO signal, the generated signal including phase information of the first LO signal; and
sample the generated signal to determine the phase of the first LO signal.

10. The wireless device of claim 9, wherein the frequency of the reference signal is an integer multiple of a frequency of the baseband clock signal.

11. The wireless device of claim 9, wherein execution of the instructions by the one or more processors causes the wireless device to:
transmit the determined phase of the first LO signal to another wireless device.

12. The wireless device of claim 9, wherein execution of the instructions by the one or more processors causes the wireless device to:
phase-shift one or more data packets in the baseband processor based, at least in part, on the determined phase of the first LO signal.

13. The wireless device of claim 9, wherein the baseband clock signal and the reference signal have a zero phase offset relative to each other.

14. The wireless device of claim 9, wherein the baseband clock signal and the reference signal have a constant non-zero phase offset relative to each other.

15. The wireless device of claim 9, wherein the first LO signal is associated with a first transmit chain of the wireless device, the reference signal is a second LO signal associated with a second transmit chain of the wireless device, and the generated signal includes phase offset information between the first LO signal and the second LO signal.

16. The wireless device of claim 15, wherein execution of the instructions to generate the signal causes the wireless device to:
mix the first LO signal and the second LO signal together.

17. A non-transitory computer-readable storage medium storing one or more programs for determining a phase of a first local oscillator (LO) signal having a frequency corresponding to a center frequency of a selected channel, the one or more programs containing instructions that, when executed by one or more processors of a wireless device, cause the wireless device to perform operations comprising:
clocking one or more operations of a baseband processor using a baseband clock signal;
generating a reference signal based at least in part on the baseband clock signal, wherein a frequency of the reference signal is within a predetermined value of the center frequency of the selected channel;
generating a signal based at least in part on the reference signal and the first LO signal, the generated signal including phase information of the first LO signal; and
sample the generated signal to determine the phase of the first LO signal.

18. The non-transitory computer-readable storage medium of claim 17, wherein the frequency of the reference signal is an integer multiple of a frequency of the baseband clock signal.

19. The non-transitory computer-readable storage medium of claim 17, wherein execution of the instructions by the one or more processors causes the wireless device to perform operations further comprising:
transmitting the determined phase of the first LO signal to another wireless device.

20. The non-transitory computer-readable storage medium of claim 17, wherein execution of the instructions by the one or more processors causes the wireless device to perform operations further comprising:
phase-shifting one or more data packets in the baseband processor based, at least in part, on the determined phase of the first LO signal.

21. The non-transitory computer-readable storage medium of claim 17, wherein the baseband clock signal and the reference signal have a zero phase offset relative to each other.

22. The non-transitory computer-readable storage medium of claim 17, wherein the baseband clock signal and the reference signal have a constant non-zero phase offset relative to each other.

23. The non-transitory computer-readable storage medium of claim 17, wherein the first LO signal is associated with a first transmit chain of the wireless device, the reference signal is a second LO signal associated with a second transmit chain of the wireless device, and the generated signal includes phase offset information between the first LO signal and the second LO signal.

24. The non-transitory computer-readable storage medium of claim 23, wherein execution of the instructions to generate the signal causes the wireless device to perform operations further comprising:
mixing the first LO signal and the second LO signal together.

25. A wireless device for determining a phase of a first local oscillator (LO) signal used for transmitting data on a selected channel, the wireless device comprising:
means for clocking one or more operations of a baseband processor with a baseband clock signal;
means for generating a reference signal based at least in part on the baseband clock signal, wherein a frequency of the reference signal is within a predetermined value of a center frequency of the selected channel; and
means for generating a signal based at least in part on the reference signal and the first LO signal, the generated signal including phase information of the first LO signal; and
means for sampling the generated signal to determine the phase of the LO signal.

26. The wireless device of claim 25, wherein the frequency of the reference signal is an integer multiple of a frequency of the baseband clock signal.

27. The wireless device of claim 25, further comprising:
means for transmitting the determined phase of the LO signal to another wireless device.

28. The wireless device of claim 25, further comprising:
means for phase-shifting one or more data packets in the baseband processor based, at least in part, on the determined phase of the first LO signal.

29. The wireless device of claim 25, wherein the first LO signal is associated with a first transmit chain of the wireless device, the reference signal is a second LO signal associated with a second transmit chain of the wireless device, and the generated signal includes phase offset information between the first LO signal and the second LO signal.

30. The wireless device of claim 29, wherein the means for generating the signal is to:
mix the first LO signal and the second LO signal together in a mixer.
